(19) United States
(12) Patent Application Publication
(10) Pub. No.: US 2020/0279328 A1
(43) Pub. Date: Sep. 3, 2020

(54) Multi-party Financial Services Agreements

(71) Applicant: Mosaique LLC, Chicago, IL (US)

(72) Inventors: Mehdi Zhiri, Chicago, IL (US); Francois Blondel, Chicago, IL (US)

(21) Appl. No.: 16/805,491

(22) Filed: Feb. 28, 2020

Related U.S. Application Data
(60) Provisional application No. 62/812,552, filed on Mar. 1, 2019.

(51) Int. Cl. G06Q 40/04; G06Q 10/10; G06Q 50/18; G06Q 20/08; G06Q 20/38; G06Q 20/06; G06Q 20/36; G06F 16/27; H04L 9/06; H04L 9/32

(52) U.S. Cl. CPC G06Q 40/04; G06Q 10/10; G06Q 50/18; G06Q 20/085; G06Q 20/38215; G06Q 20/0655; H04L 2209/56; G06Q 20/3676; G06F 16/27; H04L 9/0643; H04L 9/3213; G06Q 2220/00; G06Q 20/3678

(57) ABSTRACT

The invention pertains to a computer server configured for digitization of a multi-party market order agreement and to communicate with a distributed ledger computer system that includes multiple computing nodes, each computing node configured to store at least a partial copy of a blockchain of the distributed ledger computer system. The computer server may comprise a give-up multi-party agreement (MA) platform for digitizing, reconciling and calculating a financial transaction on the MA platform. The server may include executing account references for a derivatives order. The server may include clearing account references for the derivatives order. Further, the server may reconciliate trading limits for the derivatives order. The server may undertake an interest computation. Finally, the server may reconciliate fees for the derivatives order, product exclusions and the legal language of the legal agreement MA.

The present application claims priority to U.S. provisional application No. 62/812,552 filed Mar. 1, 2019.

The present invention pertains to the digitization of financial services agreements between multiple parties and the use of distributed ledger technology for automated reconciliation and processing of transactions.

### BACKGROUND

Use of blockchain is known for processing business transactions including Bitcoin. Bitcoin groups transactions into blocks which can generally be propagated to the whole network before a new block of transactions is produced. The block requires inclusion of a difficult to find solution to cryptographic function or hash. Each block references and builds off a previous block using cryptographic functions or hashes. Tying each block to its previous block with hash functions generates a chain of blocks containing all accepted transactions. A blockchain may provide a public record of all transactions and a current ledger of ownership, for example of the Bitcoin. The present invention is distinguished from many Bitcoin systems, as it is not a currency in and of itself, yet it uses similar distributed ledger or blockchain technology to automatically reconciliate and process a digitized multi-party financial services agreement.

### SUMMARY

The invention pertains to a computer server configured for digitization of a multi-party market order agreement and to communicate with a distributed ledger computer system that includes multiple computing nodes, each computing node configured to store at least a partial copy of a blockchain of the distributed ledger computer system. The computer server may comprise a give-up multi-party agreement (MA) platform for digitizing, reconciling and calculating a financial transaction on the MA platform. The server may include executing account references for a derivatives order. The server may include clearing account references for the derivatives order. Further, the server may reconciliate trading limits for the derivatives order. The server may undertake an interest computation. Finally, the server may reconciliate fees and trading limits for the derivatives order, product exclusions and the legal language of the said legal agreement MA.

In an embodiment, the computer server further comprises the MA for facilitating the trading of one of derivatives, futures contracts, securities and cryptocurrencies. In an embodiment, the computer server provides an automated notarizing system and system for calculating trade fees and trade limits. In an embodiment, the computer server having the notarizing system further comprising the step of providing a time stamp and output of a hash function for establishing proof of existence of the MA. In an embodiment, the computer server outputs a hash function and the output is published n times into a public or private blockchain where n is equal to the number of parties involved in the MA.

In an embodiment, the computer server providing near real-time trade affirmation. In an embodiment, the computer server providing fund settlement between parties to the MA. In an embodiment, the fund settlement may be one of atomic, gross and netted fund settlement. In an embodiment, the trade execution is handled by one of an executing broker, order passing broker and carrying broker. In an embodiment, the computer server provides verification steps that may occur by one of a pre-trade, at-trade, at-give-up, post-trade and at the same time as each of the preceding.

In an embodiment, the MA is processed by an exception engine. In an embodiment, a single company may act as one of or both the executing broker and clearing broker. In an embodiment, the trading limits are computed as the Merkle root of the Merkle tree of all trading limits to establish a specified value of the executed MA using recursivity. In an embodiment, the rates are computed as the Merkle root of the Merkle tree of all rates to establish a specified value of the executed MA using recursivity. In an embodiment, the product exclusions are computed as the Merkle root of the Merkle tree of all product exclusions to establish a specified value of the executed MA using recursivity. In an embodiment, the Merkle tree of limits, rates and product exclusions values are stored and anchor the root to the smart contract to compute the valid rates, limits and evaluate product exclusions.

In an embodiment, a balance is stored for each MA transaction represented by cryptocurrency tokens or non-cryptocurrency tokens. In an embodiment, the tokens may travel between one of customers, traders, executing brokers, clearing brokers and order passing brokers. In an embodiment, at the end of a given trading period, the method further provides for a netted view of all payables and receivables across all participants using a digital asset or token that holds no money in order to account for each movement of funds that need to be operated on a trade by trade basis. In an embodiment, the computer server computes transaction fees, execution fees, revenue sharing fees, clearing fees, commissions and exchange fees.

A further embodiment provides a method for creating, storing and executing a multi-party agreement (MA) including account references, trading limits and fees, the method comprising a first module for executing account references, a second module for clearing account references, a third module for reconciliation of trading limits and a fourth module for reconciliation of fees. The method includes a graphical user interface to generate a record of the MA transaction that includes publishing a record of the MA transaction to a distributed multi-ledger platform having multiple nodes and automatically determining an outcome of the MA transaction by verifying the set of conditions against a validation source. The method provides the MA transaction time stamp and a cryptographic hash function for establishing proof of existence of the MA. The output of the hash function is published n times into a public or private distributed multi-ledger platform where n is equal to the number of parties involved in the MA.

In an embodiment, the method further comprising executing the determination to add the record to the distributed multi-ledger platform via a consensus decision of the subset of the multiple nodes, wherein the consensus decision comprises: a validation of the cryptographic hash, associated with creation of the MA transaction, by the subset of the multiple nodes and a confirmation that the record of the MA transaction has not already been added to the distributed multi-ledger platform. In an embodiment, the method wherein the cryptographic hash comprises values generated based on specific data fields associated with the MA and wherein the consensus decision comprises validation of a cryptographic puzzle associated with a cryptographic hash. In an embodiment, the method further comprising publishing, via the graphical user interface, the outcome of the MA transaction and linking one MA transaction to multiple corresponding MA including one of a give-up agreement, one term sheet, one introducing broker agreement and calculating fees on the basis of the linked agreements.

In an embodiment, the method further comprises providing an exceptions link lead to a non-executed agreement and calculating limits on the basis of the linked agreements. In an embodiment, the method further comprising adding a representation of the MA transaction to a mobile wallet capable of tracking customized financial service transactions, wherein the representation includes a pointer to a record in the distributed multi-ledger platform.

In another embodiment, a system provides a processor; a memory, operatively connected with the at least one processor, that stores computer-executable instructions that, when executed by the at least one processor, causes the at least one processing to execute a method for creating and executing a customized financial service transaction. The method comprises receiving, through a graphical user interface that is presented to a party on a display of a party terminal, the customized financial service transaction, wherein the graphical user interface includes the following for creation of the customized financial service transaction. A first area provides for executing account references. A second area provides for clearing account references. A third area provides for reconciliation of trading limits. And a fourth area provides for reconciliation of fees and automatically determining an outcome of the customized financial service transaction by verifying the set of conditions against a validation source. The system further provides a balance stored for each customized financial service transaction represented by cryptocurrency tokens or non-cryptocurrency tokens and the tokens may travel between one of customers, traders, executing brokers, clearing brokers and order passing brokers.

In an embodiment, the system includes at least one processor for providing a validation of a cryptographic hash, associated with creation of the customized financial service transaction, by the subset of the multiple nodes and a confirmation that the record of the customized financial service transaction has not already been added to the distributed multi-ledger platform. In an embodiment, the system comprises values generated based on specific data fields associated with the customized financial service transaction, and wherein the consensus decision comprises validation of a cryptographic puzzle associated with cryptographic hash and the output of the hash function is published n times into a public or private distributed multi-ledger platform where n is equal to the number of parties involved in the MA.

In an embodiment, the record of the customized financial service transaction is in a format consumable by a verification engine that automatically determines the outcome based on the record. In an embodiment, the method, executed by the at least one processor, further comprises adding a representation of the customized financial service transaction to a mobile wallet capable of tracking customized financial service transactions, wherein the representation includes a pointer to the record in the distributed multi-ledger platform. In an embodiment, the system wherein the distributed multi-ledger platform includes a private blockchain, a hybrid blockchain or a public blockchain.

In a further embodiment, a non-transitory computer-readable storage media that stores computer-executable instructions, which, when executed by at least one processor, causes the at least one processor to execute a method. The method comprises receiving, through a graphical user interface that is presented to a party on a display of a party terminal, a customized financial service transaction, wherein the graphical user interface includes the following for creation of the customized financial service transaction. The method comprises a first area for executing account references. A second area is provided for clearing account references. A third area is provided for reconciliation of trading limits. And a fourth area is provided for reconciliation of fees, publishing the record of the customized financial service transaction to a distributed multi-ledger platform having multiple nodes and retrieving the customized financial service transaction from the distributed multi-ledger platform.

### DRAWING FIGURES

Embodiments of the present invention are described with respect to the following drawing figures:

FIG. 1 is an overview schematic diagram of a prior art system with respect to a non-digitized Give-Up Agreement Use Case;

FIG. 2 is an overview schematic diagram of a specific embodiment of the invention with respect to a solution for a Give-Up Multi-party Agreement;

FIG. 3 is a flow diagram of the hardware and systems with respect to a prior art platform including a non-digitized Give-Up Multi-party Agreement current payment flow;

FIG. 4 is flow diagram of the hardware and systems with respect to a specific embodiment of the present invention of a smart agreement platform including a digitized smart Give-Up Multi-party Agreement payment flow;

FIG. 5 is a schematic diagram depicting the hash functions and Merkle tree of the present invention; and

FIG. 6 is a schematic diagram depicting the timing of the reconciliation process of the present invention.

These and other features and advantages will be better and more completely understood by referring to the following detailed description of non-limiting illustrative embodiments in conjunction with the drawings.

### DETAILED DESCRIPTION

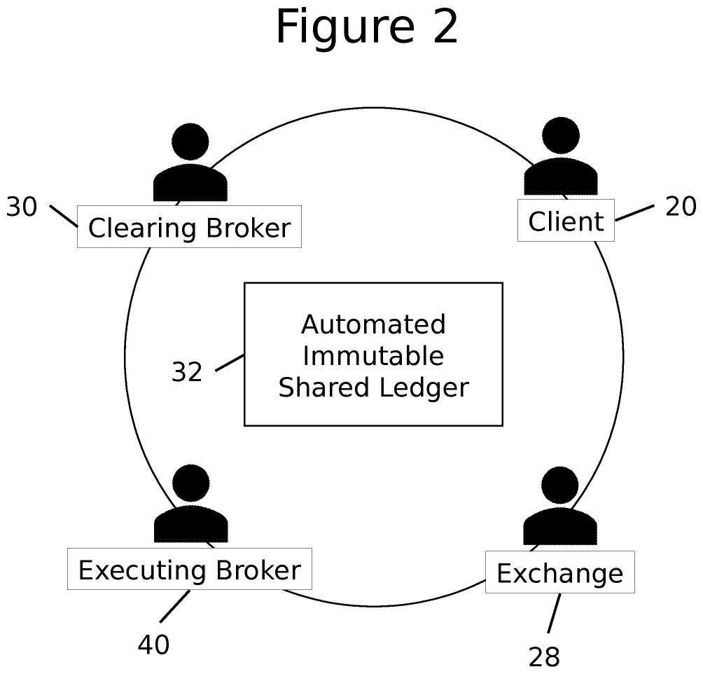

The present invention is described hereafter by referring to this detailed description and FIGS. 2 and 4-6 of embodiments of the invention. The ecosystem driving execution and clearing of listed derivatives (futures) contracts is composed of traders/customers (Asset Managers, Professional Trading Groups, Hedge Funds, Money Managers, Commodity Trading Advisors, etc.), Order Passing Brokers (Introducing Brokers), Carrying Brokers, Executing Brokers, Clearing Brokers, Exchanges and Clearing Houses. This ecosystem is global in nature due to the fact that exchanges are all over the world.

“Give-Up agreements” are agreements that set the legal frame in which an entity, named clearing broker, can negotiate multi-party market orders with an executing broker on behalf of the order initiator (a third entity or the client). A rates schedule is usually attached to such a multi-party agreement (MA) in order to define execution fees for each product that the said give-up MA is covering. Certain sections in the MA set restrictions based on conditions such as trading limits, product type, product, etc. Other sections set the process that governs rejects in the case the clearing broker cannot take a trade in.

A give-up multi-party agreement (MA) sits at the core of a complex multi-party ecosystem that is risky to manage and has ties to real-time events as well as end of day and end of month settlement and accounting events. The document nature of a give-up MA does not enable parties to manage their risk properly as it does not link into the trade flow nor the settlement process.

Digitizing the entire ecosystem is accomplished, in an embodiment, by defining an end-to-end (or agreement-to-settlement) process and methodology to keep all assets in sync, the chain of events tamper-resistant and the settlement straight-through-processing by linking document management, trade affirmation and account settlement together via smart contract technology and using a hybrid distributed ledger approach and an interoperability layer.

Blockchain is used to denote: a) a public or private, permissioned or permission less, open or close, blockchain, and/or b) a distributed ledger technology, and/or c) a directed acyclic graph technology. The invention includes a process orchestration linking smart contract technology, public blockchain and private blockchain altogether as to produce an end-to-end tamper resistant workflow that systematically produces: a) a timestamp proof of existence of any agreements and their content signed between parties, b) near real-time trade affirmation and c) granular fund settlement between trader, customer, executing broker, clearing broker and order passing broker accounts.

In an embodiment, the first step is the digitization of the give-up MA, which is a digital representation of a give-up MA including: a) the parties (from 3 to 6): customer/trader/order passing broker/carrying broker/executing broker/clearing broker, b) the customer executing account references tied to the execution part of the flow, c) the customer clearing account references tied to the clearing part of the flow, d) the payment accounts of the trader, customer, executing broker, carrying broker, clearing broker and order passing broker tied to the payment process, e) the execution fees tied to the agreed upon trade execution service fees between customer and executing broker or between trader and executing broker, f) the execution fees tied to the agreed upon introducing broker service between order passing broker and executing broker, g) the execution fees tied to the agreed upon introducing broker service between the introducing broker and clearing broker, h) trading limits (in quantity or currency amount) associated with the multi-party relationship, whether these limits are given by a clearing broker to an executing broker, or by an executing broker to a trader or to a customer and i) Products excluded from the MA (usually will change from times to times), j) the payer and payee entities, and k) the legal clauses of the MA

The digitization can be done via: a) manual data entry; b) automated input via an API; c) OCR/digitization of an existing physical paper or digital PDF/image document. The workflow governing the MA process, from initiation of an MA to signature of such MA, is managed through an application connected to private and public blockchain infrastructures. The blockchain infrastructures are used for the digital signature process attached to the MA. Each party defined in an MA signs the MA via a smart contract that operates as a notary mechanism. The notary mechanism is designed such that each party sends a message onto the public or private blockchain to such smart contract acting as a notary as to “mark their digital signature onto the agreement”. The message contains a hash representation of the agreement in its entirety: parties, rates, limits, legal language, jurisdiction, start and end dates, account references (payment, clearing and executing), and excluded products. The verification mechanism by which one third-party could confirm that a party in an MA signed such MA would require such third-party to query the public or private blockchain for a validated transaction sent by the public address of the party to the public address of the notary smart contract and containing a hash representation of the MA.

Whether in a public or private blockchain infrastructure, the MA and its associated data elements are encrypted and protected from the outside world thanks to the hash mechanism. As soon as an MA is signed by all parties and the start date (or effective date) has passed, it is considered as valid and in use. Parties could require an additional level of signature via a third-party e-signature mechanism (DocuSign for instance).

Each valid MA and its dataset are hashed, and this hash is published n times (n=3, 4, 5, 6 depending on how many parties in the MA) into the public and/or private blockchain. This allows to prove that such MA, and its underlying dataset, existed (and has been signed by all parties) at a specific date and time. The hashing mechanism could use any hash function, SHA256 for example. The usage of hybrid blockchain technology (both public and private) is to prevent proof of existence from being tampered with.

In an embodiment, the second step is to digitize the trade affirmation process and link it to the settlement mechanism. In a trade give-up scenario, each trade executed onto an exchange will go through at least 1 executing broker and 1 clearing broker. The trade is first executed by the executing broker, and then given-up to the clearing broker. The clearing-house operates in between to confirm trade events via messaging (usually XML/FIXML format). The clearing broker can accept or reject the trade (as per CFTC Rule 1.74).

A method is to link the acceptation process of a trade give-up to a smart contract that has sufficient information to prove that there is a valid trade give-up MA between the parties involved in such trade. It is also contemplated for firms to execute trades on behalf of client without a legal MA covering the specifics of the trade. This verification could take place in any of the following give-up process steps: a) prior to trade execution (pre-trade); b) during trade execution (at-trade); c) during the give-up process (at-give-up); d) after the give-up trade has been confirmed (post-trade). While these steps are listed from best scenario to a worst scenario, these steps may all be followed or just one, or multiple parts in any sequence.

The smart contract will act as an input to an exception engine if used post-trade. The trade will be prevented from being given-up if the smart contract is used at-trade or at-give-up. The trade will be prevented from being executed if the smart contract is used pre-trade. The smart contract will be one of three types and in an alternate embodiment will be defined upon interchangeable relationship. In another embodiment the relationship will be between: (1) an executing broker and a clearing broker, regardless of the trader, customer or order passing broker involved in the trade, or (2) an order passing broker and an executing broker, regardless of the trader, customer or clearing broker involved in the trade, or (3) an order passing broker and a clearing broker, regardless of the trader, customer or executing broker involved in the trade. In an embodiment, 1 smart contract per firm party type (i.e. if a firm has both roles of executing broker and clearing broker, it will appear in 2 separate smart contracts (with possibly 2 different public addresses)). There are as many smart contracts as there are relationships between executing brokers and clearing brokers, order passing brokers and executing brokers, order passing brokers and clearing brokers.

In an embodiment, interchangeable may mean if Company 1 can act as an Executing Broker or a Clearing Broker, and Company 2 can act as an Executing Broker or a Clearing Broker, then there will only be 1 smart contract representing their relationship. Same concept applies to the relationship Executing Broker/Order Passing Broker and Clearing Broker/Order Passing Broker. If a company is involved in several capacities that are found in more than 1 type of smart contract, then the company will appear in more than 1 smart contract (e.g. company can act as an Executing Broker or an Order Passing Broker).

The smart contract will be composed of: a) the public address of each one of the parties (party 1 and party 2) in the relationship it relies upon, each stored in a separate variable, b) the state of the MAs involving the rates relationship it relies upon, stored in a variable, c) the state of the MAs involving the limits relationship it relies upon, stored in a variable, d) the state of the MAs involving the product exclusions relationship it relies upon, stored in a variable, e) the balance of currency amounts owned by party 1 to party 2, each stored in a variable per each currency (as many variables as there are currencies defined) Each firm involved in an MA will have as many public addresses as it has party roles. The balance may be kept as equal to the amount that 1 firm owes to the other (positive amount) in their respective capacities. (e.g. if Company 1 acts as an executing broker and Company 2 acts as a clearing broker, the smart contract will have the public address for the executing broker entity of Company 1, and the public address for the clearing broker entity of Company 2. Additionally, if Company 1 acts a clearing broker and Company 2 acts as an executing broker, then there will be a 2^{nd} smart contract with the public address for the clearing broker entity of Company 1 and the public address for the executing broker entity of Company 2.)

The “state of the agreements involving the rates (or limits or product exclusions) relationship it relies upon” is computed as the Merkle root of the Merkle tree of all rates (or limits or product exclusions) attributes contained in all valid and signed MAs where the two parties appear in the capacity defined within the scope of the given type of the smart contract. The attributes are key fields used to define a rate (or a limit or a product exclusion) in the platform. They could be exchange code, product, product type, execution type, etc. Each time an MA is updated, the platform recalculates the Merkle root and stores the updated value in the corresponding smart contract. A Merkle tree of limits, rates and product exclusions values is stored in the platform and the roots of each Merkle tree are anchored to the smart contract so that at any point in time we are 100% sure of all the valid (i.e. agreed upon via contract signature) rates, limits and product exclusions.

The balances stored in each smart contract could be represented by cryptocurrency or non-cryptocurrency tokens. The linkage between trades and smart contracts is performed by sourcing necessary information from both the platform and the smart contract, and from: a) If at-trade or pre-trade: the execution feed coming from an Order Management System of the Executing Broker or the Customer/Trader or the Order Passing Broker, or any distributed ledger where the trade execution will be broadcasted to; b) If at-give-up: the middle-office system(s) used by the Executing Broker or the Order Passing Broker to perform the give-up, or any distributed ledger where the trade execution will be broadcasted from; or c) If at post-trade: the clearing house feed (usually denoted as ACK messages coming out of the FIXML feed), or any distributed ledger where the trade give-up instruction will be broadcast from.

The linkage mechanism will match a trade to an MA (or multiple MAs) by getting attributes directly from the fields in the source system described previously and by then verifying whether those attributes combined together correspond to a rate, a limit or a product exclusion that is contained in the corresponding Merkle trees whose Merkle roots are stored in the relevant smart contract.

If there is a match for a product exclusion, then the give-up is “refused” if at-trade or at-give-up, or the trade does not execute if pre-trade, or the give-up trade is sent to an exception engine if post-trade.

If there is a match for a rate, then the give-up is “pending approval” and a number of steps are kicked off: a) limit value (stored in the limit engine) for the product of the trade is increased/decreased (depending on trade direction) by an amount equal to the trade quantity and/or currency amount, b) if there is a match for a limit, then the limit value (i) found in the Merkle tree is compared to the limit value computed in a) previously (ii). If (ii) is greater than (i), then the give-up is rejected and the source system is informed of the rejection. If (ii) is less or equal than (i) then a number of steps are kicked off: a) the give-up is approved and the source system is informed of the approval and can continue it's normal operation of either executing the trade or giving-up the trade, b) trade execution fee is computed by using the appropriate rate in the platform and a fee calculation engine, c) trade is linked to the MA to which the appropriate rate is attached to, and d) balances owed by the relevant parties in the smart contract increased by an amount equal to the trade execution fee.

In the case the linkage mechanism does not find a match, the platform will: a) in the case of pre-trade: reject the execution, b) in the case of at-trade or at-give-up: reject the give-up process, and c) in the case of post-trade: “flag” trades for exception management.

Trades flagged for exception will be reprocessed either manually or automatically at the choice of the user. If automatically, the user could choose a time trigger (hourly, same day end of day, next day before market opening, next day end of day, etc.)

In an embodiment Step 3 occurs at the end of trading/end of the day. (Referring to step 2 specifically) all smart contracts in the system will be displaying currency balances pertaining to trade executions. The settlement of fund will be performed based on the gross and/or net view of the entire or partial population of smart contracts depending on how the platform is operating or depending on how the user would like to do so.

We are using either a cryptocurrency token or a non-cryptocurrency token that will travel between Customers, Traders, EBs, CBs and Order Passing Brokers in order to settle fees across the entire network. In the case of a cryptocurrency token, the funds will be considered settled in real-time without the need to interface with an external banking system like ACH or SWIFT.

In the case of a non-cryptocurrency token, and at the end of a given period, which could be hourly, daily, monthly, or ad-hoc, the method allows for having a netted view of all payables and receivables across all participants, thus requiring to perform fund movement (money movement via SWIFT or equivalent outside the platform) only when money is due and on a net fund basis. This is achieved by using a digital asset (token) that holds no money but accounts for each movement of funds that may be operated on a trade by trade basis.

In an embodiment, the step of computing daily inter-company interest accrual in cases where payments are instructed on a monthly (not daily) basis.

In an embodiment, Step 4 provides a method for providing an interoperability layer between blockchain platforms. The layer will allow communication of information between existing or future distributed ledger platforms, post-trade and accounting platforms. As previously described, and for identification purposes, we intend for the smart contract to contain the public keys of the participants on the platform it operates on. As to incorporate an interoperability layer, we also intend to enrich the smart contract with the public keys of the same participants on other blockchain platforms or networks they may be part of. A representation of the linkage will also be “hashed” into a public blockchain infrastructure. The data that will be hashed will be comprised of the keys that it links together and the public address of the contract that contains the link. Any third-party will be able to prove that the contract is effectively the one operating the link by simply querying the contract to retrieve the special hash and confirm it by recalculating it via publicly known information (the public keys). The mechanism by which one could verify the legitimacy of the smart contract for interoperability across multiple platforms could be repeated many times in the form of a Merkle tree as to verify that a population of smart contract are legitimate. Thus, calculating the “root” of a Merkle tree would be a very efficient way to confirm the health of a given ecosystem linking multiple platforms. The concept of link we just described can be used as a deterministic way to verify that information coming from a different blockchain platform belongs to one or more participants within a given MA.

Although process steps, or the like, including without limitation with reference to the steps described herein, may be described or claimed in a particular sequential order, such processes may be configured to work in different orders or steps. For example, any sequence or order of steps that may be explicitly described or claimed in this document do not necessarily indicate a requirement that the steps be performed in that order. The steps or processes described herein may be performed in any order contemplated by one of ordinary skill in the art. As well, some steps may be performed simultaneously (or in parallel) despite being described or implied as occurring non-simultaneously (e.g., because one step is described after the other step). Also, the illustration of a process by its depiction in a drawing does not imply that the illustrated process is exclusive of other variations and modifications thereto, does not imply that the illustrated process or any of its steps are necessary, and does not imply that the illustrated process is preferred.

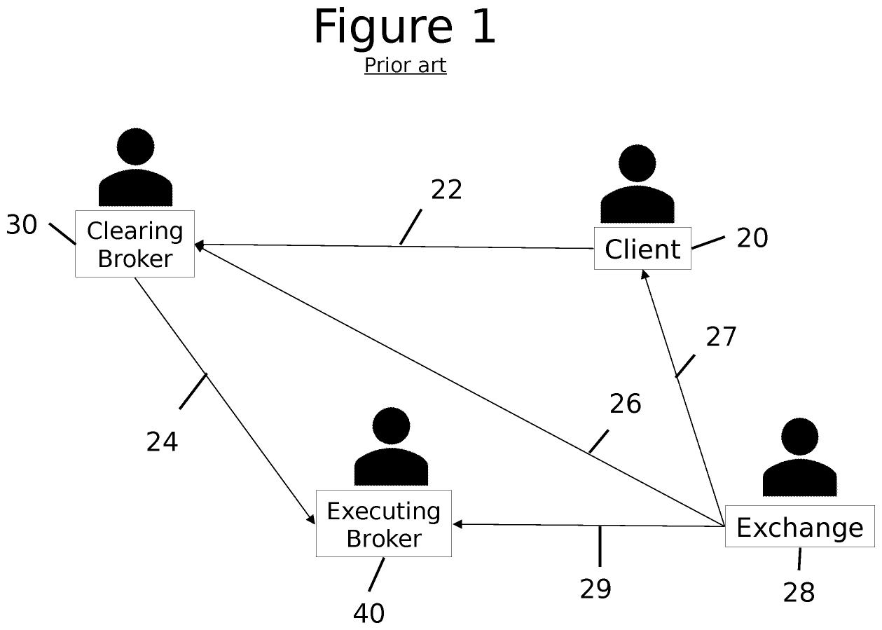

Turning to FIG. 1, a schematic diagram of a MA prior art use case is depicted that shows a client 20, clearing broker 30 and executing broker 40. At step 22 under the current non-automated system, full rates are paid for the executing fees and clearing fees. At step 24 the clearing broker pays the executing fees to the executing broker 40. At step 26 the exchange 28 relays data regarding the trade to the clearing broker 30. At step 27 the exchange 28 relays data regarding the trade to the client 20. At step 29 the exchange relays trade data to the executing broker 40. Frictions exist in such a non-automated system including data duplication, rate disputes, late payment and wrong payments due to the fact that each entity 20, 30, 40 have their own dataset 26, 27 and 29 and multiple reconciliations are required to establish an agreement on the rates to be paid out.

The prior art give-up use case involves, for example, a listed derivative trade being executed by an executing broker (EB) 40, while the clearing of the same trade is performed by a different clearing broker (CB) 30. Account payable and account receivable (A/P and A/R) 24 are at the core of the trade execution fee process between CB 30 and EB 40. The customer/client 20 who initiates the trade has cash accounts with the CB 30 in order to pay both the clearing fee and execution fee 22 to CB 30. The CB 30 then pays the execution fee 24 to the EB of record 40.

A payable is an invoice due by a CB 30 to an executing EB 40 for execution services 24. A receivable is the opposite side of a payable 24. A multi-party agreement (MA) (give-up agreement) is usually executed by and between the customer/client 20, EB 40 and CB 30, in order to define the service level agreement including execution fees 24. Invoices are usually triggered monthly based on pre-defined execution rates found in the give-up agreement (MA).

Turning to FIG. 2 the solution to the prior art system is disclosed where an automated, immutable, shared ledger 32 is used amongst the exchange 28, client 20, CB 30 and EB 40, to process an MA entered pursuant to a trade. The MA is digitized into a smart contract 32 and the smart contract is synchronized across all parties via a shared and immutable ledger. The present invention addresses the problems of data duplication and rate disputes.

The MA 32 automates the A/P and A/R process via an event-based and exception management engine encompassing the ledger, pre and/or post-trade systems and payment networks. The present invention addresses the problems of late payments and wrong payments.

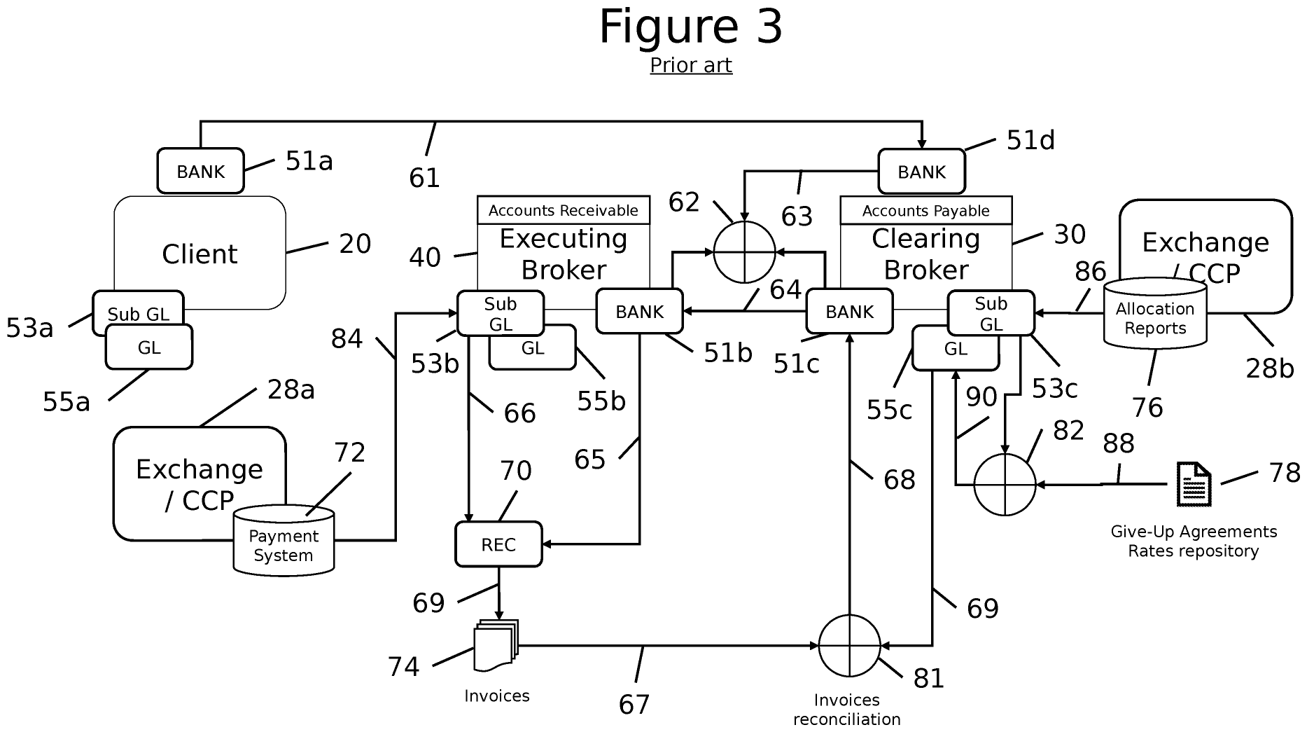

Turning to FIG. 3 a flow diagram of the institutions, parties and some of the hardware used for MA payment flow for a current prior art system. The client 20 executes a MA with a CB 30 and EB 40. The MA lists legal language, exchanges 28a,b, products, execution types, associated executing and clearing accounts and execution fee rates, trading limits and product exclusions. Then the client 20 (via exchange 28a,b) initiates a trade. EB 40 executes the trade. EB 40 gives-up the trade to CB 30 for clearing (via CCP 28a,b). CB 30 clears the trade. Then client 20 pays full service fees 61 to CB 30. EB 40 then invoices CB 30 for executing fees. CB 30 pays executing fees 64 to EB 40 (via banks 51b,c).

Continuing with FIG. 3, the payment system 72 allow for EB 40 to retrieve payments made via on-exchange or off-exchange platform 28a,b, along with executed trades, and reconciles with payments received in bank accounts 51b. The breaks serve as an input to create invoices to CB 30 for A/R. The CB 30 retrieves give-in trades cleared from exchange/CCP 28a,b, calculates fees owed to EB 40 via the give-up MAs and rate repository and reconciles results with invoices received from EB 40. Then CB 30 pays to EB 40 invoices matched to A/P (via bank 51c to bank 51b)

Bank reconciliation 62, 63 occurs between Client 20, CB 30 and EB 40 amongst engaged banks 51b,c,d. Bank 51b provides for reconciliation 65 for payments and the reconciliation (REC) 70 requires a Sub GL 53b, usually a back-office platform, a solid reconciliation toolkit and fees engine 69 to handle invoices 74. The step 67 of invoices reconciliation 81 to bank 51c and GL 55c via step 69. A payment system 72 is associated with exchange 28a and provides for reconciliation step 84 with Sub GL 53b. An MA 78 via step 88 provides for calculation of execution fees 82 via step 90 to GL 55c.

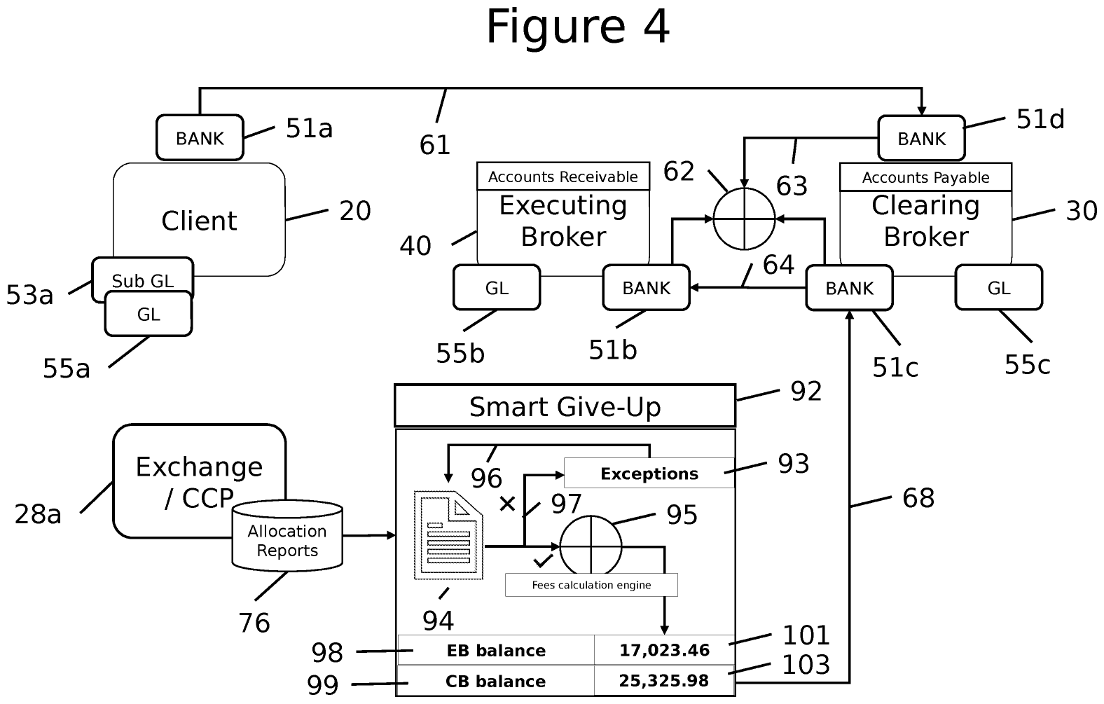

Turning to FIG. 4, the present invention is depicted by showing smart give-up payment flow. Like numerals in FIG. 3 are provided in FIG. 4 and represent like components. Smart give-up platform 92 digitizes the entire MA between client 20, CB 30 and EB 40 including the execution fee rates 64 according to fee calculation engine 95. Smart give-up platform 92 acts as a source of truth for the MA by the various participants 20, 30, 40. A light reconciliation process is operated by feeding trade information from the exchanges 28a through allocation reports 76 and matching them with fee rates 95 attached to the digitized MA 94. The balance of what is owed (E.g. EB balance 98 of, for example, $17,023.46 (101) and CB balance 99 of, for example, $25,325.98 (103) is automatically calculated by adding computed fees 95 to the existing smart contract balances 101,103. Balances are then automatically netted across the entire population of smart contracts and payment instructions 68 subsequently sent to bank 51c to instruct payment to bank S b. An exceptions engine 93 receives trades for which no fee was matched to and re-inject them into the matching process 96, 94 on an event trigger basis.

For each embodiment described herein where blockchain technology is used for a particular purpose or feature, it should be understood that blockchain technology (or Merkle tree) is just one example of a technology that may be used for such purpose/feature. In various other embodiments, other types of distributed ledger technology, distributed database technology, and/or smart contracts technology may be used in place of and/or in conjunction with blockchain technology for such purpose/feature.

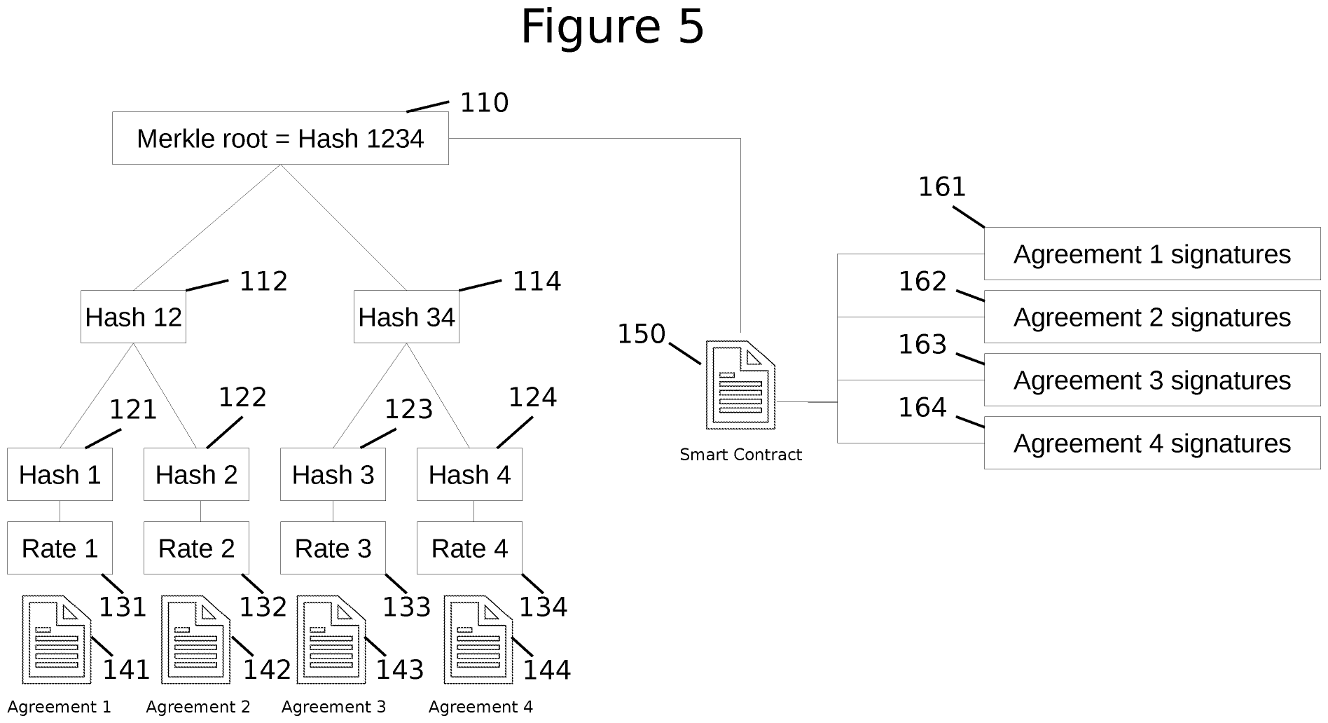

Turning to FIG. 5 the mechanism by which a smart contract 150, corresponding to a pair executing broker/clearing broker (or order passing broker/executing broker or order passing broker/clearing broker) holds the data relevant to all MAs signed between the 2 parties in questions (and other parties involved in same agreement) including the rates attached to each of these MAs. The Merkle root 110 is computed for the Merkle tree where each leaf 112, 114 corresponds to the hash output 121-124 of the hash function of a rate 131-134 (computed as a hash output of the concatenation of all the rate attributes: product, execution type, exchange, value, currency, etc.) that is attached to an agreement between a pair executing broker/clearing broker, or eb/opb or cb/opb. This way the Merkle root represents a cryptographic signature of all the rates that belong to all the MAs 141-144 that are between a given pair EB/CB, or EB/OPB or CB/OPB. The Merkle root is anchored to the smart contract 141-144 for later reference to it during the reconciliation process. The Merkle tree is stored in a database in the fee calculation engine. Additionally, the smart contract 150 has a notary function that stores the digital signature 161-164 from each party to the MAs that are between a given pair EB/CB, EB/OPB or CB/OPB. Those signatures (or a representation of them) 161-164 are anchored to the smart contract 150 and their values stored in the blockchain.

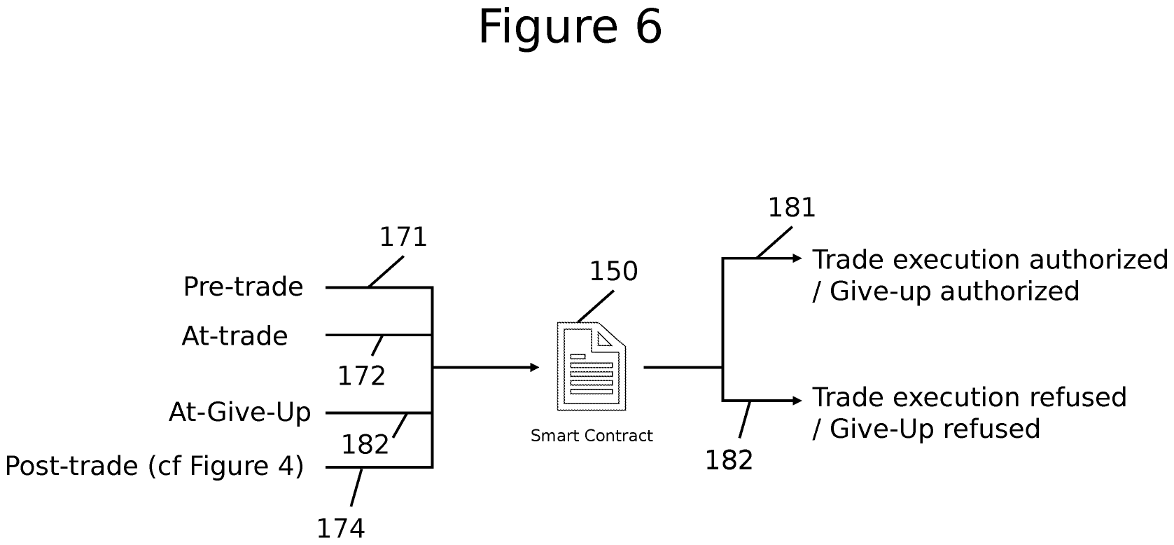

In FIG. 6 is shown the other ways the smart contract can be utilized. In FIG. 4, we have represented a reconciliation process from the clearing house dataset, i.e. a post-trade scenario. The smart contract 150, as shown in FIG. 6, could be queried pre-trade 171, at-trade 172, at-give-up 173 or post-trade 174 (as shown also in FIG. 4) as to verify that the trade is allowed, or the give-up is allowed 181. If trade is allowed, then several subsequent steps including fees and limits calculations will be triggered as discussed with respect to FIG. 4. Verification that the trade is refused, or the give-up is refused 182 may also be provided.

Although various embodiments have been shown and described in detail, the claims are not limited to any particular embodiment or example. None of the above descriptions should be taken as implying that any particular element, step, range, or function is essential. All structural and functional equivalents to the elements of the above-described preferred embodiment that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, component, or step in this specification is intended to be dedicated to the public. Further, the present invention may be applicable to other agreements or platforms other than Give-Up Agreements. For example, the present invention may be applicable to legal agreements such as Introducing Broker agreements, Term Sheets, Letters of Credit or to asset classes such as derivatives, securities (equities and fixed income), crypto-currency, OTC or other financial arrangements.

What is claimed is:

1. A computer server configured for digitization of a multi-party market order agreement and to communicate with a distributed ledger computer system that includes multiple computing nodes, each computing node configured to store at least a partial copy of a blockchain of the distributed ledger computer system, the computer server comprising:
a give-up multi-party agreement (MA) platform for digitizing, reconciling and calculating a financial transaction, the MA platform a) executing account references for a derivatives order; b) clearing account references for the derivatives order; c) reconciliating trading limits for the derivatives order; d) interest computation; and e) reconciliating of fees for the derivatives order; and f) the product exclusions; and g) the legal language of the said legal agreement MA

2. The computer server of claim 1 further comprising the MA for facilitating the trading of one of derivatives, futures contracts, securities and cryptocurrencies.

3. The computer server of claim 1 further comprising the MA platform providing an automated notarizing system and system for calculating trade fees.

4. The computer server of claim 3 wherein the notarizing system further comprising the step of providing a time stamp and output of a hash function for establishing proof of existence of the MA.

5. The computer server of claim 4 wherein the output of the hash function is published n times into a public or private blockchain where n is equal to the number of parties involved in the MA.

6. The computer server of claim 1 further comprising the MA platform providing fund settlement between parties to the MA and wherein the fund settlement may be one of atomic, gross and netted fund settlement.

7. The computer server of claim 1 wherein trade execution is handled by one of an executing broker, order passing broker and carrying broker.

8. The computer server of claim 1 providing verification steps that may occur by one of a pre-trade, at-trade, at-give-up, post-trade and at the same time as each of the preceding.

9. The computer server of claim 1 wherein the MA is processed by an exception engine and wherein a single company may act as one of or both the executing broker and clearing broker.

10. The computer server of claim 1 further comprising a balance stored for each MA transaction represented by cryptocurrency tokens or non-cryptocurrency tokens.

11. The computer server of claim 10 wherein the tokens may travel between one of customers, traders, executing brokers, clearing brokers and order passing brokers.

12. The computer server of claim 10, wherein at an end of a given trading period, the method further provides for a netted view of all payables and receivables across all participants using a digital asset or token that holds no money in order to account for each movement of funds that need to be operated on a trade by trade basis and wherein the computation of transaction fees includes execution fees, trade fees, clearing fees, commissions and exchange rates.

13. A method for creating, storing and executing a multi-party agreement (M A) including account references, trading limits and fees, the method comprising:
a first module for executing account references; a second module for clearing account references; a third module for reconciliation of trading limits; and a fourth module for reconciliation of fees, a graphical user interface to generate a record of the MA transaction that includes publishing a record of the MA transaction to a distributed multi-ledger platform having multiple nodes and automatically determining an outcome of the MA transaction by verifying the set of conditions against a validation source and wherein the MA transaction providing a time stamp and a cryptographic hash function for establishing proof of existence of the MA, the output of the hash function is published n times into a public or private distributed multi-ledger platform where n is equal to the number of parties involved in the MA.

14. The method of claim 13, further comprising, executing the determination to add the record to the distributed multi-ledger platform via a consensus decision of the subset of the multiple nodes, wherein the consensus decision comprises: a validation of the cryptographic hash, associated with creation of the MA transaction, by the subset of the multiple nodes and a confirmation that the record of the MA transaction has not already been added to the distributed multi-ledger platform.

15. A system comprising:
at least one processor, a memory, operatively connected with the at least one processor, that stores computer-executable instructions that, when executed by the at least one processor, causes the at least one processing to execute a method for creating and executing a customized financial service transactions, the method comprising: receiving, through a graphical user interface that is presented to a party on a display of a party terminal, the customized financial service transaction, wherein the graphical user interface includes the following for creation of the customized financial service transaction: a first area for executing account references; a second area for clearing account references; a third area for reconciliation of trading limits; and a fourth area for reconciliation of fees and automatically determining an outcome of the customized financial service transaction by verifying the set of conditions against a validation source; and wherein a balance is stored for each customized financial service transaction represented by cryptocurrency tokens or non-cryptocurrency tokens and the tokens may travel between one of customers, traders, executing brokers, clearing brokers and order passing brokers.

16. The system of claim 15, wherein the method, executed by the at least one processor, further comprises: a validation of a cryptographic hash, associated with creation of the customized financial service transaction, by the subset of the multiple nodes and a confirmation that the record of the customized financial service transaction has not already been added to the distributed multi-ledger platform.

17. The system of claim 15, wherein the cryptographic hash comprises values generated based on specific data fields associated with the customized financial service transaction, and wherein the consensus decision comprises validation of a cryptographic puzzle associated with cryptographic hash and the output of the hash function is published n times into a public or private distributed multi-ledger platform where n is equal to the number of parties involved in the MA.

18. The system of claim 15, wherein the record of the customized financial service transaction is in a format consumable by a verification engine that automatically determines the outcome based on the record.

19. The system of claim 15, wherein the method, executed by the at least one processor, further comprises: adding a representation of the customized financial service transaction to a mobile wallet capable of tracking customized financial service transactions, wherein the representation includes a pointer to the record in the distributed multi-ledger platform and

20. The system of claim 15, wherein the distributed multi-ledger platform includes a private blockchain, a hybrid blockchain, or a public blockchain.
